(19) United States
(12) Patent Application Publication
(10) Pub. No.: US 2007/0007197 A1
(43) Pub. Date: Jan. 11, 2007

(54) System and method for synthesizing a polymeric membrane

(76) Inventors: Mailvaganam Mahendran, Mississauga (CA); Hua Chen, Burlington (CA); Kwon II Kim, Burlington (CA); Wayne Jerald Henshaw, Burlington (CA)

Correspondence Address: BERESKIN AND PARR, 40 KING STREET WEST, BOX 401, TORONTO, ON, M5H 3Y2, CA

(21) Appl. No.: 11/400,177

(22) Filed: Apr. 10, 2006

Related U.S. Application Data
(63) Continuation of application No. PCT/CA04/01846, filed on Oct. 20, 2004.
(60) Provisional application No. 60/512,081, filed on Oct. 20, 2003.
(60) Provisional application No. 60/527,718, filed on Dec. 9, 2003.

(51) Int. Cl. B01D 71/26

(52) U.S. Cl. 210/500.36; 210/490; 210/500.42; 264/41; 427/245

(57) ABSTRACT

A method of synthesizing a polymeric membrane is described in which a polymer, for example a polyvinylidene polymer or a terpolymer of ethylene, chlortrifluoroethylene and an acrylic monomer is heated and blended with a solvent. The solvent may be a high boiling latent solvent, for example butyl benzyl phthalate or tri iso nonyl trimellitate. The heated blend is shaped, which may involve casting on a supporting material such as a braided tube. Subsequently, the blend is cooled to thereby induce polymeric membrane formation on the supporting material.

This is a continuation of International Application No. PCT/CA2004/001846 filed Oct. 20, 2004, which claims priority to U.S. Application Ser. No. 60/512,081 filed Oct. 20, 2003 and U.S. Application Ser. No. 60/527,718 filed Dec. 9, 2003. All of the applications listed above are incorporated herein, in their entirety, by this reference to them.

### FIELD OF THE INVENTION

This invention relates to membranes, and more specifically to a method or system for synthesizing a polymeric membrane, for example a membrane usable for ultrafiltration or microfiltration made using a thermally induced phase separation process.

### BACKGROUND OF THE INVENTION

The following description does not admit or imply that the apparatus or methods discussed below are citable as prior art or part of the common and/or general knowledge of a person skilled in the art in any particular country.

Polymeric membranes have many applications. For example, polymeric membranes are used for microfiltration and ultrafiltration in water and wastewater treatment, pharmaceutical, biomedical and food industries. Polymeric membranes also find use in dialysis, membrane distillation, membrane solvent extraction, membrane gas absorption and stripping.

Polymeric membranes have been prepared by a variety of methods including thermally induced phase separation (TIPS). In the TIPS process, the polymer, for example polyvinylidene fluoride, is mixed with a solvent system optionally including a nonsolvent or nucleating agents. The mixture is heated to form a homogeneous solution. When the solution is fast quenched or cooled, phase separation occurs in the mixture, leading to the formation of a porous structure after the solvent is removed.

### SUMMARY OF THE INVENTION

Notwithstanding the fact that TIPS can yield a membrane with desirable characteristics, these processes, as currently implemented, have some drawbacks. One drawback is that some polymers, such as polyvinylidene fluoride, may be useful in many applications but are not durable in applications where they must be cleaned in certain chemicals such as sodium hydroxide. Another drawback is that TIPS processes may produce membranes with very dense outside structures, resulting in low permeability. Conventional TIPS processes may also yield membranes with tensile break strengths of about 1 to 15 N/mm2. These tensile strengths are too small for many applications. In addition, the use of mixed solvents or nonsolvents in the production process makes it difficult to recover them for recycling or proper disposal. Also, many TIPS processes yield a membrane that has a pore size greater than 0.1 microns or an insufficient bubble point pressure, which makes them unsuitable for many ultrafiltration applications.

It is an object of this invention to improve on, or at least provide a useful alternative to, the prior art. It is another object of the invention to provide a membrane, a composition usable in forming a membrane or a system or method for producing a membrane, for example a polymeric hollow fiber microfiltration or ultrafiltration membrane. The following summary is intended to introduce the reader to the invention but not to define it. The invention may reside in a combination or sub-combination of elements or steps found in this summary and/or in other parts of this document, for example the claims.

In one aspect, the invention provides a membrane comprising a tubular support made of braided yarns and a polymeric membrane bonded to the outer surface of the tubular support. The polymeric membrane comprises a terpolymer of ethylene, chlorofluoroethylene and an acrylic based monomer.

In another aspect, the invention provides one or more compositions comprising a polymer and a latent solvent. A latent solvent may also be referred to as a diluent, and the words “diluent” and “latent solvent” will be used interchangeably in this document. The polymer and latent solvent are present in proportions sufficient to form at a generally homogenous mixture at a blending temperature. The polymer and latent solvent are also present in proportions useful for melt spinning into a hollow fiber form in a thermally induced phase separation process to produce a membrane usable for ultrafiltration or microfiltration. The composition may comprising, for example, a terpolymer of ethylene, chlorofluoroethylene and an acrylic based monomer and a trimellitate latent solvent or a polyvinylidene fluoride polymer and butyl benzyl phthalate.

In another aspect, the invention provides a method of synthesizing a polymeric membrane comprising blending and heating a composition as described above. The heated and blended composition is shaping into a desired form and then cooled to induce polymeric membrane formation.

In another aspect, the invention provides a method of synthesizing a polymeric membrane comprising blending and heating a composition having a polymer a latent solvent. The blended and heated composition is coated onto a support, such as a tubular support of braided fibers, and then cooled to induce formation of a polymeric membrane that remains affixed to the braid for support.

In another aspect, the present invention provides a process for produce a membrane in a thermally induced phase separation process. The membrane may have one or more desirable characteristics such as small mean pore size, for example 0.1 microns or less, high permeability, for example 10 gfd/psi or more, 20 gfd/psi or more or 40 gfd/psi or more, chemical resistance, for example chemical resistance to cleaning in sodium hydroxide, high tensile strength, for example as provided by a tubular support, or high bubble point, for example 25 psi or more or 30 psi or more.

In another aspect, the invention relates to a method using a high boiling latent solvent in a thermally induced phase separation process to produce a polyvinylidene fluoride membrane. The membrane may be in the form of a hollow fiber.

In another aspect, the invention relates to a method for producing a membrane using a high boiling latent solvent in a TIPS process to produce a membrane using an ethylene polymer. The ethylene polymer may include an ethylene chlorotrifluoroethylene copolymer, or an ethylene chlorotrifluoroethylene butylacrylate (ECBA) terpolymer.

In another aspect, a method of synthesizing a polymer membrane is described which includes blending and heating a polyvinylidene compound with a high boiling latent solvent. The method may further include adding an optional nucleating agent. The high boiling solvent may be a solvent that boils at about 350° C. or greater and into which the polyvinylidene fluoride polymer mixes to yield a homogeneous solution at a temperature of about 100° C. or greater. The high boiling latent solvent may be benzyl butyl phthalate. The solution is shaped into a desired form, which may be a follow fiber. Subsequently, the blend is cooled, such as by quenching, to thereby induce polymer membrane formation, and the solvent is extracted to make the membrane porous.

In another aspect, a method of synthesizing a polymer membrane is described which includes blending and heating a polyethylene chlorotrifluoroethylene butylacrylate terpolymer compound with a high boiling latent solvent. A nucleating agent may optionally be added. The high boiling solvent may be a solvent that boils at about 250° C. or greater and into which the polyethylene chlorotrifluoroethylene butylacrylate terpolymer mixes to yield a homogeneous solution at a temperature of about 100° C. or greater. The high boiling latent solvent may be trimellitate. The mixture is then shaped into a desired form, which may be a follow fiber. Subsequently, the blend is cooled, such as by quenching, to thereby induce phase separation and solidification of the polymer rich phase. An extraction solvent, such as isopropyl alcohol, can then be used to remove the latent solvent to form a porous membrane. A subsequent soak in NaOH solution may then be used to remove the nucleating agent, if any, which further increases the membrane permeability.

### BRIEF DESCRIPTION OF THE DRAWINGS

For a better understanding of the present invention and to show more clearly how it may be carried into effect, reference will now be made, by way of example, to the accompanying drawings, in which:

FIG. 1 shows a flowchart for synthesizing a polymer membrane, according to the teachings of the present invention.

FIG. 2 shows a system for producing a hollow fiber membrane supported on a tubular braid.

FIG. 3 shows a cross-sectional scanning electron microphotograph of a polyvinylidene fluoride hollow fiber membrane produced by thermal induced phase separation.

FIG. 4 shows and outside skin scanning electron micrograph of the polyvinylidene fluoride hollow fiber membrane.

### DETAILED DESCRIPTION OF EXEMPLARY EMBODIMENTS

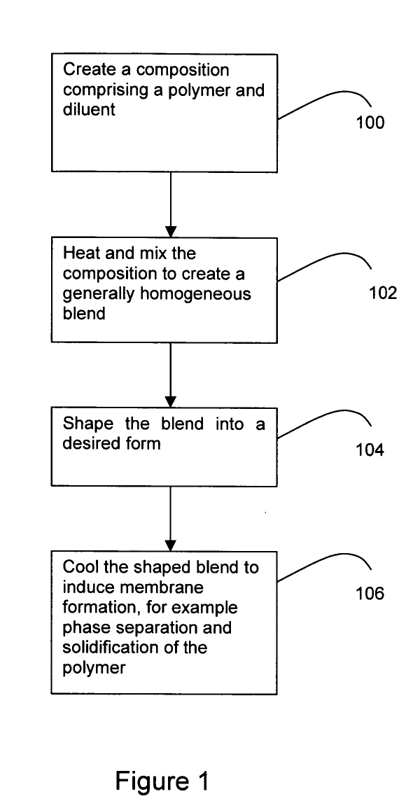

FIG. 1 shows a flowchart for synthesizing a polymer membrane. In step 100, a composition of a polymer and a solvent is created, optionally with a nucleating agent. In step 102, the composition is heated and mixed to generally homogenize or blend the composition. The heating is done to a blending temperature that is sufficiently high to allow the polymer to form a solution with the diluent. Steps 100 and 102 may optionally be performed partially or generally simultaneously. In step 104, the blend is shaped into a desired form. This may involve coating the blend onto a supporting material. Subsequently, in step 106, the blend is cooled to thereby induce formation of a polymer membrane that remains affixed to the supporting material, if any. In particular, the cooling causes phase separation, for example into a polymer rich phase and a polymer lean phase, and solidification of the polymer resulting in a polymer membrane optionally disposed on the supporting material. Later extraction of the solvent makes the membrane porous and useful for, among other things, liquid separation processes such as microfiltration or ultrafiltration. The used solvent can be recycled after being extracted from the membrane with an extraction solvent, and then separated from the extraction solvent, minimizing waste discarded into the environment. In some embodiments, the membrane has one or more of a mean pore size of 0.1 microns or less, a bubble point of 20 psi or more or 30 psi or more or a permeability of 10 gfd/psi or more, 20 gfd/psi or more or 40 gfd/psi or more.

Returning to the composition, the polymer can include, or be substantially or entirely comprised of, a polyvinylidene compound such as a polyvinylidene fluoride polymer. Polyvinylidene fluoride polymers are generally fluorine compounds having the chemical structure of —(CH₂—CF₂)ₙ— (where n is a positive integer) and having an average fluoride content of about 60 percent in one repeat unit. As used herein, the term “polyvinylidene fluoride polymer” or “polyvinylidene fluoride compound” includes vinylidene fluoride homopolymers, and random and block copolymers of vinylidene fluoride. Examples of such copolymers include vinylidene fluoride-hexafluoropropylene copolymers, vinylidene fluoride-tetrafluoroethylene copolymers, vinylidene-ethylene copolymers, vinylidene fluoride-chlorotrifluoroethylene copolymers and vinylidene fluoride-perfluorovinylether copolymers. Terpolymers, physical blends of polymers of polyvinylidene fluoride polymers, as well as mixtures of the aforementioned compounds, also fall under the rubric of “polyvinylidene fluoride polymer/compound.” In some embodiments of the present invention, polymers with an ordered crystalline structure, in which methylene groups and methylene difluoride groups are bonded alternately, and/or polymers having an average molecular weight of about 150,000 or greater are preferably used.

The polymer can alternately include, or be substantially or entirely comprised of, an ethylene polymer. The ethylene polymer may be an ethylene chlorotrifluoroethylene copolymer (ECTFE) or, preferably, an ethylene chlorotrifluoroethylene terpolymer. ECTFE copolymers are sold, for example, by Ausimont USA, Inc. under the name HALAR™. Useful ethylene chlorotrifluoroethylene terpolymers include terpolymers of ethylene, chlorotrifluoroethylene and an acrylic based monomer, such as butylacrylate or acrylic acid, also called 2-propenoic acid. An ethylene chlorotrifluoroethylene butylacrylate terpolymer may be referred to in this document as ECBA for brevity. A useful ECBA polymer is sold as XPM-2 by Solvay Solexis. The ethylene chlorotrifluoroethylene terpolymer, or ECBA in particular, preferably has a melt temperature of under 200 degree Celsius, or between 190 degrees Celsius and 200 degrees Celsius, which is advantageously well below its degradation temperature of about 240 degrees Celsius to 260 degrees Celsius. This aids in the formation of a TIPS membrane, particularly a membrane shaped onto a support, compared to other polymers, such as ECTFE, which may have higher melting points or less range between their melt and degradation temperatures. ECBA also advantageously possesses strong chemical resistance to both chlorine and alkaline substances, such as sodium hydroxide. This is a useful characteristic since alkaline substances may be used to extract nucleating agents, if any, or to clean the membranes in use, for example in jurisdictions where cleaning with chlorine or other chemicals is not permitted.

The solvent may be a high boiling latent solvent. As used in this document, a high boiling solvent is a solvent that boils at about 250° C. or greater, or 350° C. or greater, and a latent solvent is a solvent into which a solute, for example the polymer of the composition, melts or dissolves to yield a generally homogeneous solution at a temperature of about 100° C. or greater. A high boiling latent solvent is a solvent having both these characteristics. For example, in some embodiments, the high boiling latent solvent used, benzyl butyl phthalate, substantially dissolves the polyvinylidene fluoride compound at about 100° C. Other useful high boiling latent solvents include dibutyl phthalate, triacetin, glyceryl diacetin, triisononyl trimellitate, tri isodecyl trimellitate, tri-n-hexyl trimellitate and butyl phthalyl butyl glycolate. Of these, benzyl butyl phthalate, dibutyl phthalate and triacetin are preferred and benzyl butyl phthalate most preferred, for use with a polyvinylidene fluoride polymer. The listed trimellitates are preferred, and triisononyl trimellitate most preferred for use with an ethylene chlorotrifluoroethylene terpolymer. Tri iso nonyl trimellitate is a low volatility, high molecular weight monomeric plasticizer. Tri iso nonyl trimellitate is also well characterized and commercially available, finding use in the manufacture of high temperature PVC wire and cable solution. A useful tri iso nonyl trimellitate is sold under the trademark JAYFLEX by Exxon Chemical.

The amount of the solvents used in the composition is advantageously sufficient to itself solubilize the polymer at the extrusion, molding, or casting temperature; that is, the diluent is the essential dissolving constituent. Preferably, no other solvent other than the high boiling latent solvent is necessary to solubilize the polymer. The target pore size of the membrane, transport rate through the membrane, and membrane strength are dictated by the ultimate use of the membrane, and these factors may be considered in determining the exact appropriate blend composition. The precise concentrations of the components of the blend may also be chosen in view of the desired characteristics of the blend during the shaping step.

The optional nucleating agent may be one or more of talc, silica, fumed silica, calcium carbonate and alumina. If silica or fumed silica is used, a large surface area (greater than 100 m2/g) is advantageous. The nucleating agent may increase the viscosity of the blend to aid in shaping, and may increase the tensile strength of the resulting membrane. The nucleating agent can be dispersed in the diluent first before loading the polymer or alternatively the nucleating agent can be added into the polymer diluent solution after the polymer is melted or dissolved.

For forming the membranes of this invention, the concentration of polymer in the composition or blend is preferably at least about 10 weight percent, more preferably at least about 15 weight percent, even more preferably at least about 18 weight percent; the concentration of polymer is preferably less than about 90 weight percent, more preferably less than about 75 weight percent, even more preferably less than about 60 weight percent. The concentration of the solvent is preferably at least about 20 weight percent, more preferably at least about 40 weight percent; the concentration of the solvent is preferably less than about 90 weight percent, more preferably less than about 85 weight percent. The concentration of the nucleating agent, if any, is preferably at least about 0.01 weight percent, and more preferably at least about 0.1 weight percent. The concentration of the nucleating agent is preferably less than about 20 weight percent, more preferably less than about 10 weight percent. For further example, the polymer may be present in between about 18 and 30 weight percent, with the single polymer and single diluent present in about 90 weight percent or more and the nucleating agent, if any, present in about 0.5 to 10 weight percent. In this document, the composition may be referred to at various times as one or more of a blend, solution, mixture or other similar terms. With ECBA in particular, if the weight percentage of ECBA is too low, for example less than 18%, the resulting blend may not be sufficiently viscous to extrude. On the other hand, if the weight percentage of ECBA is too high, for example more than 30%, the composition may not gel into a useful solid.

In the mixing and heating step 102, the polymer and diluent form a generally homogeneous solution. The polymer and the solvent may be heated and mixed in any convenient manner with conventional mixing equipment, such as a jacket-heated batch mixer. Alternatively, the composition may be homogenized by first extruding the mixture through a twin screw extruder, cooling the extrudate, and grinding or pelletizing the extrudate to a particle size that is readily fed to a single or twin screw extruder. The components of the mixture, for example pellets of polymer and the liquid diluent, may also be combined directly in a melt-pot or twin-screw extruder. Some of these processes combine steps 100 and 102 .

The mixture is heated to a temperature that results in a homogeneous mixture possessing a viscosity suitable for extrusion, spinning or molding. The temperature should not be so high as to cause significant degradation of the polymer. However, the temperature should not be so low as to render the mixture too viscous to extrude and heating to above the polymer melting point reduces the mixing time. The blend temperature for extrusion, molding or spinning is preferably at least about 100° C., more preferably 200 degrees Celsius or more, and preferably less than about 250° C., more preferably about 240° C. or less.

The step of shaping 104 can proceed using a number of methods, which can be divided into two classes, depending on whether the resultant membrane is supported by another material (Class I), or unsupported (Class II).

To produce a Class I (supported) membrane, the polymer blend can be extruded around a tubular support, which may be macroporous. The tubular support can be a tube of braided fibers, which may be called a braid or tubular braid in this document for brevity, such as polyester, nylon or glass fiber. The tubular braid may have an outside diameter between about 0.5 mm to 3.5 mm and an inner diameter of about 0.25 mm to 2.5 mm. Further details of the braid, including a method of manufacturing same, are provided in US Pat. No. 6,354,444 B1, the contents of which are incorporated herein by this reference. For example, the braid may comprise between 16 and 60 separate yarns, each on its own carrier, each yarn being multifilament 150 to 500 denier yarn, each multifilament being made from 25 to 750 filaments, each filament being from 0.5 to 7 denier, woven in a pattern selected from Diamond, Regular or Hercules, with from 1 to 3 multifilament ends at form 30 to 45 picks with a wall thickness in the range from about 0.2 mm to less than three times the diameter of the yarns, and having an air permeability of at least 1 cc/sec/cm2 at 1.378 kPa. Other tubular supports, macroporous tubular supports, or textile tubular supports may also be used.

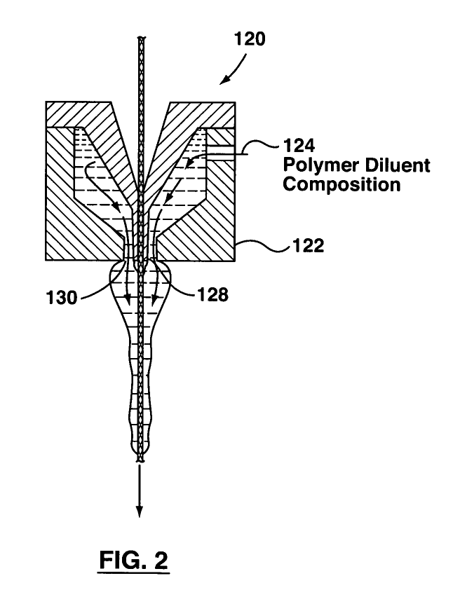

FIG. 2 shows a system 120 for producing a braid supported hollow fiber membrane. The system 120 includes a die 122 having an inlet 124 and a braid 126. The homogenized blend is introduced into the die 122 via the inlet 124. The blend is extruded through a coating nozzle 128 onto the braid 126. The blend is introduced into the coating nozzle 128 at a flow rate determined by the speed that the tubular braid 126 is advanced through a rounding orifice 130 of the coating nozzle 128. The flow rate may provide only as much blend as can be supported on the outer portion of the braid 126 such that the blend does not penetrate into the lumen of tubular braid 126. No bore fluid or outer fluid, that is a fluid applied to the outside of the extruded blend, is required.

One Class II method involves spinning a homogeneous blend. The blend should possess a suitable viscosity for spinning at a given temperature, such as a viscosity of about 2×10³ to 1×10⁵ centipoises. The mixture may be spun at an elevated temperature depending upon the viscosity of the solution and the cloud point. The mixture is preferably spun at a temperature of about 100° C. to 250° C., preferably between about 200° C. and 240° C.

For example, a hollow fiber membrane may be formed using a tube-in-orifice spinnerette. The axial passageway of the spinnerette carries a lumen forming fluid used to prevent the collapse of the hollow fiber as it exits the spinnerette. The lumen forming fluid may be selected from a wide variety of liquids, such as polyethyleneglycol 400-dimethacrylate (PEG 400), and inert gases such as nitrogen. Other substances that may be used as the lumen forming fluid include: a non-solvent for the polymer; a weak solvent or high boiling latent solvent for the polymer; or mixtures thereof. The composition and temperature of the lumen forming fluid may effect the pore size and distribution. The outwardly concentric passageway carries a homogeneous blend including the polymer and diluent. The membrane is shaped when the blend exits the spinnerette. The lumen fluid is transported to the extrusion head by means of metering pumps. The streams are individually heated and transported along thermally insulated pipes. The lumen fluid and the membrane forming solution are brought to substantially the same temperature in a closely monitored temperature zone where the blend is shaped. When spinning either a Class I or Class II membrane, the spinnerette and all the attached lines should be heated to above the cloud point of the solution.

After shaping, the blend is then cooled to induce phase separation and polymer solidification, and thereby yielding the polymer membrane. In class I methods, the polymer adheres to the support and for example, forms an outer coating on the hollow braid. The membrane has very good adhesion to the braid. In particular, the polymer membrane remains affixed to the braid during the working life of the membrane, the braid providing support thereto. Thus, a supported hollow fiber results that has extraordinary tensile strength.

In the case of spun membranes, using either a bore fluid or a tubular support, the extrudate exiting the spinnerette enters one or more quench or coagulation zones. The environment of the quench or coagulation zone may be gaseous or liquid or a combination thereof. Within the quench or coagulation zone, the extrudate is subjected to cooling and/or coagulation to cause phase separation and solidification of the membrane. Within the quench zone, the membranes gel and solidify.

In an embodiment, the membranes are quenched first in air. The temperature of the air zone, which may be directly adjacent the outlet of the spinnerette, is preferably less than about 150° C., more preferably less than about 100° C. The residence time in the air zone is preferably less than about 100 seconds, more preferably less than about 20 seconds, even more preferably less than about 5 seconds.

Subsequent to or instead of the air quench, the membrane may optionally or additionally be quenched or coagulated in a liquid by passing through a bath of the liquid. The liquid may be substantially a non-solvent for the polymer, such as water, or a mixture of water and/or other optional non-solvents. If water is the quenching fluid, the removal of the solvent from the membrane is limited because the solvents of this invention have low solubility in water. The temperature of the liquid quench or the coagulation zone is preferably at least 0° C., more preferably at least about 2° C.; the temperature of the liquid quench or coagulation zone is preferably less than about 180° C., more preferably less than about 150° C., even more preferably less than about 120° C. Other substances that may be used as the quenching fluid include: a non-solvent for the polymer; a weak solvent or high boiling latent solvent for the polymer; or mixtures thereof.

The residence time in the liquid quench or coagulation zone at the liquid quench temperature should be sufficient to gel and solidify the membranes. The residence time in the quench or coagulation liquid is preferably less than about 120 seconds, more preferably less than about 60 seconds. As the extruded polymer/solvent mixture cools, phase separation of the polymer and the solvent occurs. Phase separation results in discrete regions of solvent being formed in the membrane. These regions, when ultimately leached out, form the pores for the membrane.

To remove the diluent, an appropriate extraction solvent that does not dissolve the polymer, but which is miscible with the high boiling latent solvent, is used to remove the latter from the finished membrane. For example, isopropyl alcohol, at 0° C.-75° C., can be used as the extraction solvent for many diluents by soaking the membrane in a bath of the extraction solvent. When a nucleating agent is used, the nucleating agent may also be removed after phase separation to increase permeability. For example, silica or fumed silica in an ethylene chlorotrifluoroethylene terpolymer membrane can be partially or substantially removed by soaking the membrane in sodium hydroxide.

Details of various experimental methods for producing membranes are now provided.

In a first experimental method, a polyvinylidene fluoride hollow fiber membrane is synthesized by a thermally induced phase separation process. In particular, a solution of 25% (w/w) of polyvinylidene fluoride powder, manufactured and sold by Solvay Solexis, and 75% (w/w) of benzyl butyl phthalate, manufactured and sold by Ferro, are mixed and heated in a reactor.

After the solution has been mixed for 3 hours at 220° C., the resultant blend is degassed at 220° C. for 2 hrs. Next, the blend is extruded through a spinnerette having an annular, hollow-fiber spinning nozzle operating a spinning rate of 5m/min. This extrusion step is also conducted at 220° C. The blend is extruded into water at room temperature, forming a hollow fiber membrane. The extruded hollow fiber is immersed in isopropyl alcohol at 20° C. for 3 hours to extract the benzyl butyl phthalate from the hollow fiber. Subsequently, the hollow fiber is annealed in 60° C. water for 1 hr. The hollow fiber thus obtained has an outside diameter of 0.9 mm and an inside diameter of 0.6 mm.

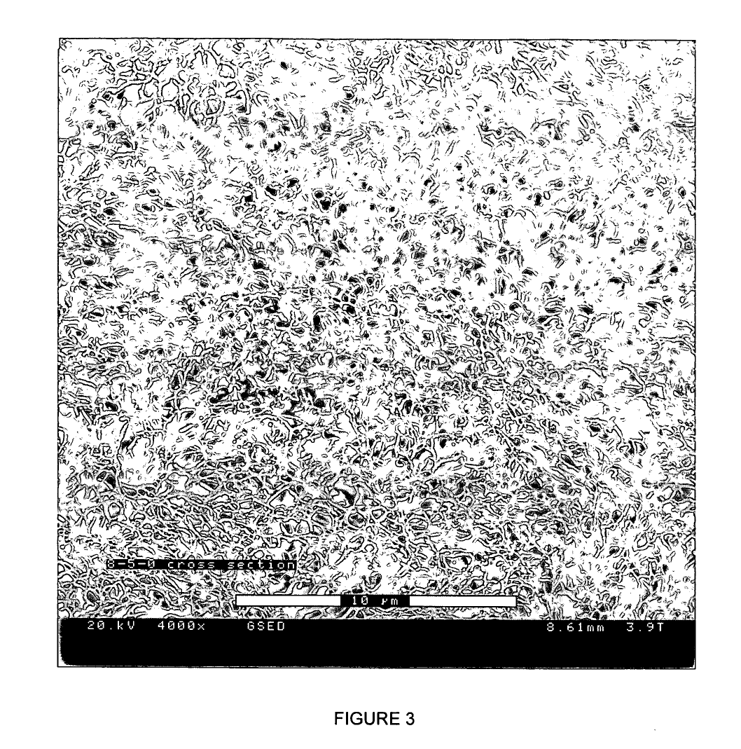

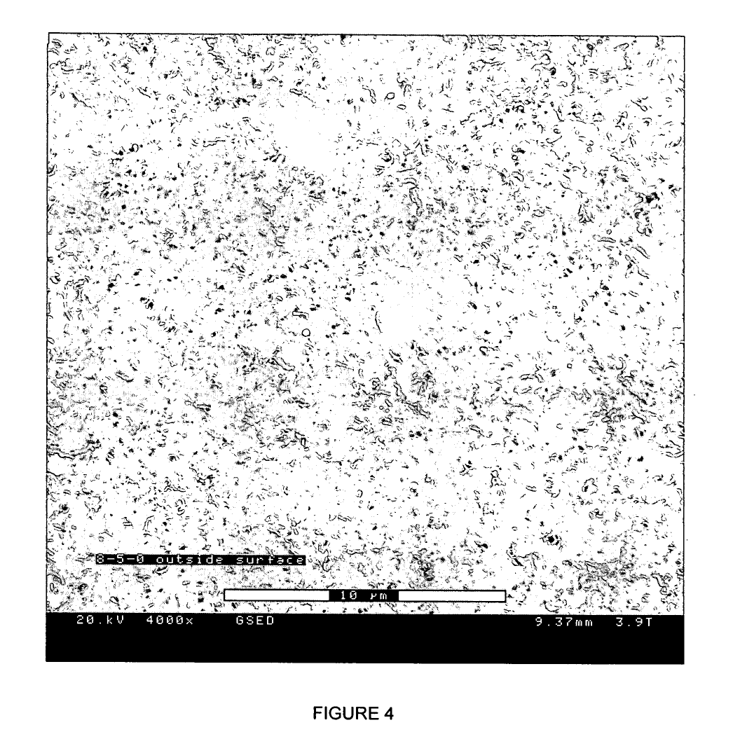

FIG. 3 shows a cross-sectional scanning electron microphotograph of the polyvinylidene fluoride hollow fiber membrane produced by thermal induced phase separation. FIG. 4 shows an outside skin scanning electron micrograph of the polyvinylidene fluoride hollow fiber membrane.

Measurements made by using analytical methods provide the following data for this structure.

mean pore size (from scanning electronic micrograph): 0.1 micron

burst pressure: 40 psi

tensile strength at break: 1.2 lb/m²

water permeability (measured under 5 psi and 20° C.): 12.5 gfd/psi,

where gfd denotes the units of gallons/(days×square feet)

Another experimental method produces a polyvinylidene fluoride polymer, hollow-fiber membrane on a braid by thermal induced phase separation. In particular, a solution of 24.5% (w/w) of polyvinylidene fluoride powder, manufactured and sold by Solvay Solexis, 74.5%(w/w) of benzyl butyl phthalate, manufactured and sold by Ferro, and 1% (w/w) hydrophobic silica, manufactured by Aerosil™, are mixed and heated in a reactor.

The resultant blend is degassed at 220° C. for 2 hours. Next, the blend is extruded at 220° C. on a polyester-based hollow braid through a spinnerette having an annular, hollow-fiber spinning nozzle.

The extruded fiber on the braid is quenched in tap water at room temperature and solidified, forming a hollow fiber membrane. The extruded hollow fiber is immersed in isopropyl alcohol at 20° C. for 3 hours to extract the benzyl butyl phthalate therefrom. The fiber is then annealed at 120° C. for 5 min. The resultant fiber has a 1.9 mm outer diameter and the following characteristics:

mean pore size (from scanning electronic micrograph): 0.04 microns

burst pressure: >25 psi

water permeability: 11.5 gfd/psi

Another experimental method produces an ethylene polymer hollow-fiber membrane on a braid by thermal induced phase separation. Six examples involving such an ethylene polymer are now described.

### EXAMPLE 1

25% by weight of ECBA terpolymer (XPM-2 produced by Solvay Solexis) and 75% by weight of a tri-isononyl trimellitate (Jayflex™, produced by Exxon Mobil Chemical ) are mixed in a reactor and heated up to 230° C .

By means of a hollow fiber apparatus such as shown in FIG. 2, the mixture obtained is extruded into a hollow fiber on the braid made of polyester synthetic fiber. The hollow fiber is quenched in water and is immersed in pure isopropyl alcohol at room temperature for 10 hours to extract the tri-isononyl trimellitate latent solvent. Next, the hollow fiber is washed in water for 1 hour. The porous membranes thus obtained have a three dimensional porous structure. Physical characteristics of the resultant membrane are listed in Table 1.

### EXAMPLES 2 to 5

A porous membrane of an ECBA terpolymer is obtained in the same way as in example 1 except that several different concentrations of the ECBA were used as follows:

(weight % of ECBA terpolymer)

| | |
|---|---|
| Example 2. | 30% |
| Example 3 | 27% |
| Example 4 | 20% |
| Example 5 | 18% |

Physical characteristics of the resultant porous membranes are listed in Table.1.

### EXAMPLES 6 to 7

A porous membrane of an ECBA terpolymer is obtained in the same way as in Example 1 except that several different quench temperature can be used as follows:

(quench temperature)

| | |
|---|---|
| Example 6 | 40° C. |
| Example 7 | 80° C. |

### EXAMPLE 8

24% by weight of an ECBM terpolymer (XPM-2, produced by Solvay Solexis) and 76% by weight of a tri iso octyl trimellitate (produced by Exxon Mobil Chemical ) are mixed in a reactor and heated to 230° C. The extrusion and post treatment are performed as in Example 1. The physical characteristics of the resultant membranes are listed in Table 1.

### EXAMPLE 9

The porous membranes obtained in Example 1 is annealed at 100° C. for 10 minutes. The physical characteristics of the resultant membrane are listed in Table 1.

TABLE 1

| | fiber out | wall | pore size | bubble | |
|---|---|---|---|---|---|
| | diam. | thickness | (mean) | pt. | Permeability |
| | (mm) | (mm) | (μm)) | (psi) | (gfd/psi) |
| ex. 1 | 1.97 | 0.185 | 0.06 | 30.0 | 50.2 |
| ex. 2 | 1.97 | 0.185 | 0.03 | 50.4 | 3.2 |
| ex. 3 | 1.95 | 0.175 | 0.04 | 40.2 | 8.3 |
| ex. 4 | 1.96 | 0.18 | 0.1 | 5.0 | 207.4 |
| ex. 5 | 1.96 | 0.18 | 0.19 | 2.3 | 304.5 |
| ex. 6 | 1.97 | 0.185 | 0.06 | 28.0 | 49.8 |
| ex. 7 | 1.97 | 0.185 | 0.07 | 27.6 | 48.0 |
| ex. 8 | 1.97 | 0.185 | 0.02 | 70.0 | 1.0 |
| ex. 9 | 1.97 | 0.185 | 0.05 | 32.0 | 48.5 |

The polymer membranes provided by the present invention are useful for membrane-based solid liquid separation processes, such as microfiltration or ultrafiltration as in water or wastewater treatment or other applications. Various modifications may be made to the embodiments herein, without departing from the scope of the invention.

What is claimed is:

1. A membrane comprising a tubular support made of braided yarns and a polymeric membrane bonded to the outer surface of the tubular support, the polymeric membrane comprising a terpolymer of ethylene, chlorofluoroethylene and an acrylic based monomer.

2. The membrane of claim 1 wherein the acrylic based monomer is one of butyl acrylate or acrylic acid.

3. The membrane of claim 1 wherein the acrylic based monomer is butyl acrylate.

4. The membrane of claim 1 wherein the terpolymer has a melting point of 200 degrees Celsius or less.

5. A composition comprising, a) terpolymer of ethylene, chlorofluoroethylene and an acrylic based monomer and b) a trimellitate latent solvent in an amount sufficient to form a generally homogenous mixture with the terpolymer at a blending temperature, wherein the terpolymer and solvent are present in proportions useful for melt spinning into a hollow fiber form in a thermally induced phase separation process to produce a membrane usable for ultrafiltration or microfiltration.

6. The composition of claim 5 wherein the acrylic based monomer is one of butyl acrylate or acrylic acid.

7. The composition of claim 5 wherein the terpolymer has a melting point of 200 degrees Celsius or less.

8. The composition of claim 5 wherein the solvent is one of tri iso heptyl trimellitate, tri iso octyl trimellitate or tri iso nonyl trimellitate.

9. A composition comprising, a) polyvinylidene fluoride polymer and b) butyl benzyl phthalate in an amount sufficient to form a generally homogenous mixture with the polymer at a blending temperature, wherein the polymer and butyl benzyl phthalate are present in proportions useful for melt spinning into a hollow fiber form in a thermally induced phase separation process to produce a membrane usable for ultrafiltration or microfiltration.

10. The composition of claim 9 wherein the blending temperature is 100 degree Celsius or greater.

11. A method of synthesizing a polymeric membrane, the method comprising,
blending and heating a composition having a polymer a latent solvent;
coating a tubular support of braided fibers with the blended and heated composition; and
cooling the composition coating the tubular support to induce formation of a polymeric membrane that remains affixed to the braid for support.

12. The method of claim 11, wherein the polymer includes at least one of a polyvinylidene compound and an ethylene compound.

13. The method of claim 11 wherein the polymer has a boiling point of 200 degrees Celsius or less.

14. The method of claim 11 wherein the solvent is a high boiling latent solvent characterized by having a boiling point of about 250° C. or greater, and having a temperature at which the polymer melts therein of about 100° C. or greater.

15. The method of claim 14, wherein the high boiling latent solvent includes at least one of butyl benzyl phthalate, dibutyl phthalate, triacetin, glyceryl diacetin, triisononyl trimellitate, tri isodecyl trimellitate, tri-n-hexyl trimellitate and butyl phthalyl butyl glycolate.

16. The method of claim 1 1 wherein the composition comprises, a) terpolymer of ethylene, chlorofluoroethylene and an acrylic based monomer and b) a trimellitate latent solvent in an amount sufficient to form a generally homogenous mixture with the terpolymer at a blending temperature, wherein the terpolymer and solvent are present in proportions useful for melt spinning into a hollow fiber form in a thermally induced phase separation process to produce a membrane usable for ultrafiltration or microfiltration.

17. The method of claim 1 1 wherein the composition comprises, a) polyvinylidene fluoride polymer and b) butyl benzyl phthalate in an amount sufficient to form a generally homogenous mixture with the polymer at a blending temperature, wherein the polymer and butyl benzyl phthalate are present in proportions useful for melt spinning into a hollow fiber form in a thermally induced phase separation process to produce a membrane usable for ultrafiltration or microfiltration.

18. The method of claim 11 wherein inducing formation of a polymeric membrane comprises causing a phase separation of the polymer and solvent and solidification of the polymer.

19. A polymeric membrane made by the method of claim 11 having a mean pore size of 0.1 microns or less.

20. A membrane made by the method of claim 11 having a bubble point of 30 psi or more.

21. A membrane made by the method of claim 11 having a permeability of 20 gfd/psi or more.
